(19) United States
(12) Patent Application Publication
(10) Pub. No.: US 2007/0156909 A1
(43) Pub. Date: Jul. 5, 2007

(54) Proxy for extending IMS services to mobile terminals with SMS capabilities

(76) Inventors: William Richard Osborn, Cary, NC (US); Jesse W. Bennett, Apex, NC (US); Daniel James Robertson, Puttenham (GB)

Correspondence Address: COATS & BENNETT/SONY ERICSSON, 1400 CRESCENT GREEN, SUITE 300, CARY, NC, 27511, US

(21) Appl. No.: 11/374,686

(22) Filed: Mar. 14, 2006

Related U.S. Application Data
(60) Provisional application No. 60/754,763, filed on Dec. 29, 2005.

(51) Int. Cl. G06F 15/16

(52) U.S. Cl. 709/227

(57) ABSTRACT

A SMS/MMS Proxy maintains SIP user identities in an IMS network on behalf of SMS capable mobile terminals to give legacy mobile terminals a presence in the IMS network. The SMS/MMS Proxy includes an application server to translate text messages received from a mobile terminal via a gateway into SIP transactions and uses the SIP user identities allocated to said mobile terminals to conduct SIP transactions on their behalf.

### RELATED APPLICATIONS

This application claims the benefit of U.S. Provisional Patent Application 60/754,763 filed Dec. 29, 2005, which is incorporated herein by reference.

### BACKGROUND

The IP multimedia subsystem (IMS) has been developed to provide a common, standardized architecture and standardized interfaces for providing IP services in a mobile networking environment. The IMS network is not dependent on the access technology and will interoperate with virtually any type of mobile communication network, including GSM, GPRS, EDGE, UMTS and cdma2000 networks. IMS uses the session initiation protocol (SIP) as the service control protocol, which allows operators to offer multiple applications simultaneously. The IMS standard is expected to speed the adoption of IP services for mobile terminals, allowing users to communicate via voice, video, or text using a single client on the mobile terminal.

Although IMS promises a richer experience to mobile subscribers, network operators are hesitant to invest in equipment to implement IMS until there are a sufficient number of subscribers with IMS capability to make the investment worthwhile. Most cellular telephones currently in use do not implement SIP and lack inherent IMS capabilities, so the pool of potential subscribers for IMS services is relatively small. Extending IMS capabilities to legacy mobile terminals that lack inherent IMS capabilities would provide a much broader market for network operators and encourage investment in IMS technology and equipment.

### SUMMARY

The present invention extends IMS services to non-SIP devices by providing a proxy to maintain a presence in the IP network on behalf of the non-SIP devices. The proxy is configured to maintain SIP user identities in the IP network for non-SIP devices and to conduct SIP transactions using those user identities on behalf of the non-SIP devices. The proxy translates text messages from the non-SIP devices into corresponding SIP transactions and conducts the corresponding SIP transactions on their behalf.

The non-SIP devices may, for example, comprise cellular phones or other mobile terminals with SMS capabilities. A cellular gateway connects the IP network with a cellular network to translate messages between SMS or MMS and SIP formats. The non-SIP devices may use SMS to send control information and/or service requests to the proxy, which are translated by the proxy into corresponding SIP transactions. Through the proxy, virtually any services offered to SIP devices in the IP network can be extended to cellular phones with SMS capability.

### BRIEF DESCRIPTION OF THE DRAWINGS

FIG. 1 is a functional block diagram of a wireless communication network including a cellular/IMS gateway and SMS/MMS Proxy.

FIG. 2 is a block diagram illustrating the basic components of an exemplary cellular/IMS gateway.

FIG. 3 is a block diagram illustrating the basic components of an exemplary SMS/MMS Proxy.

FIG. 4 is a ladder diagram illustrating an exemplary subscribe/notify process for receiving notifications.

FIG. 5 is a ladder diagram illustrating an exemplary subscribe/notify process for providing notifications.

FIG. 6 is a ladder diagram illustrating a first exemplary process for controlling a remote device.

FIGS. 7A and 7B are a ladder diagram illustrating a second exemplary process for controlling a remote device.

### DETAILED DESCRIPTION

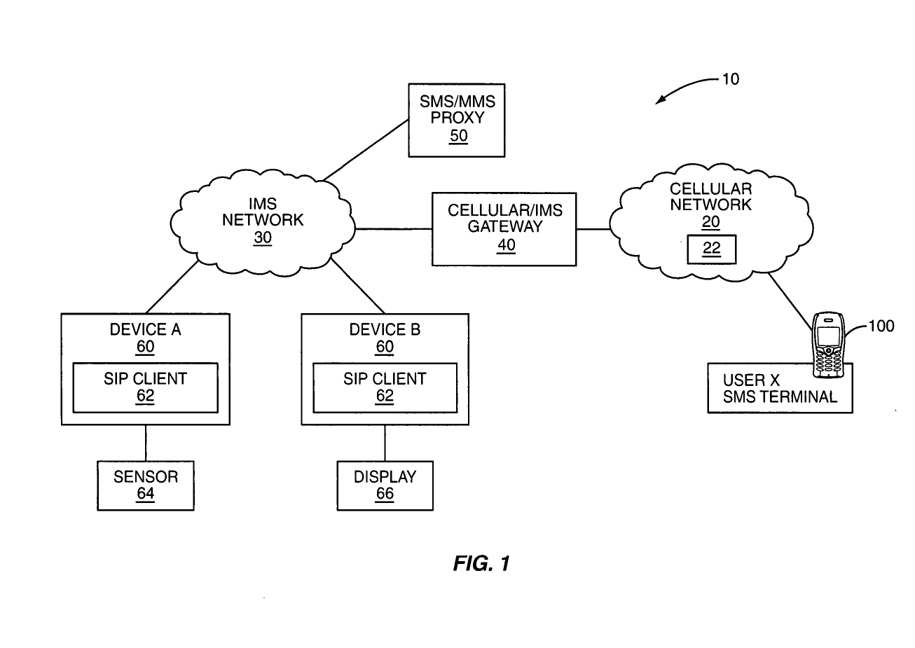

FIG. 1 illustrates a mobile communication network 10 according to one exemplary embodiment of the invention. The mobile communication network 10 comprises a conventional cellular network 20 providing voice and/or data services and an IP network 30 interconnected with the cellular network 20 providing IP services. A mobile terminal 100 lacking inherent IMS capabilities is shown in communication with the cellular network 20. The cellular network 20 may, for example, comprise a GSM, GPRS or EDGE network, although other access technologies can also be used. The cellular network 20 includes a messaging center 22 for providing SMS and/or MMS services to the mobile terminal 100. The IP network 30 may, for example, comprise an IP Multimedia Subsystem (IMS) network. The IMS network 30 uses the Session Initiation Protocol (SIP) as a signaling protocol for communication between end devices. SIP is a text-based signaling protocol used for setting-up, modifying, and tearing down media sessions. SIP has also been extended for instant messaging and presence services. A cellular/IMS gateway 40 interconnects the cellular network and the IMS network 30 to allow SMS and/or MMS messages to be delivered to and from the mobile terminal 100 via the IMS network 30. In this exemplary embodiment, the cellular/IMS gateway 40 converts SMS and/or MMS messages into SIP messages, and vice versa.

A SMS/MMS Proxy 50 is connected to the IMS network 30, though it may reside within the IMS network 30. SMS/MMS Proxy 50 provides a presence in the IMS network 30 for the mobile terminal 100. Mobile terminal 100 uses the short message service (SMS) or multimedia message service (MMS) to send command messages via the cellular/IMS gateway 40 to the SMS/MMS Proxy 50. The cellular/IMS gateway 40 converts the command messages into standard SIP requests and forwards the converted command messages to the SMS/MMS Proxy 50. By sending command messages to the SMS/MMS Proxy 50 through the cellular/IMS gateway 40, mobile terminal 100 can perform a wide variety of control and monitoring tasks. SMS/MMS Proxy 50 can also be used to provide services, such as presence services, to other IMS devices.

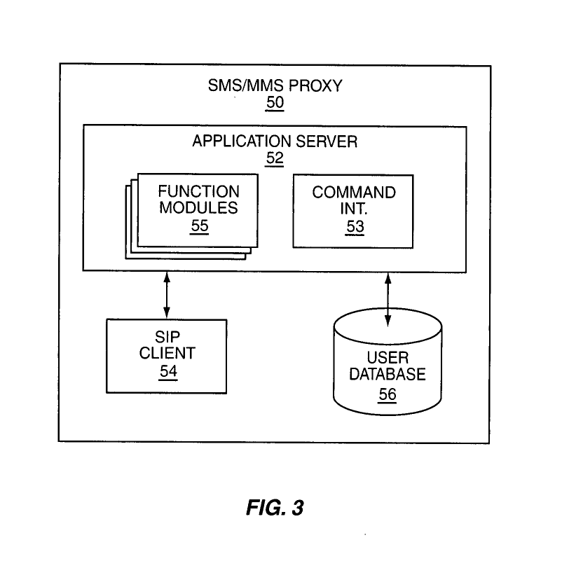

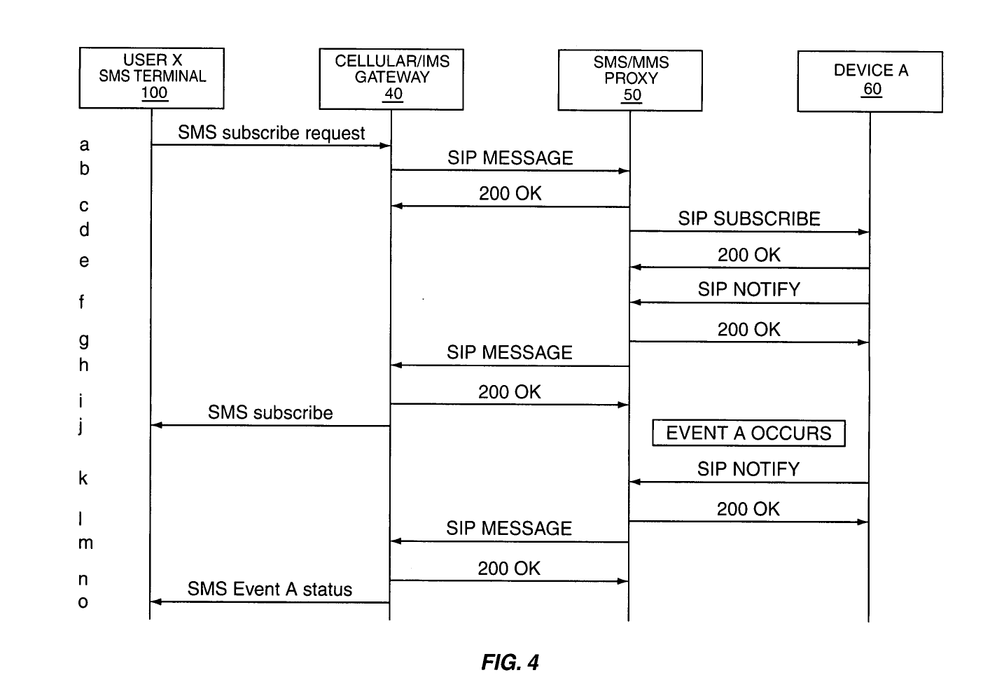

FIG. 1 shows two end devices 60, denoted as Device A and Device B connected to IMS 30. End devices 60 each include a SIP client 62 for communicating with other end devices. Device A represents a machine-to-machine (M2M) device that monitors a sensor 64 and reports when a specific event occurs. The SMS/MMS Proxy 50 enables the mobile terminal 100 to establish a subscription with Device A to receive notifications from Device A. An exemplary subscribe/notify process is shown in FIG. 3. Device B represents an M2M device that connects to a display 66. The SMS/MMS Proxy 50 enables the mobile terminal 100 to remotely update display 66. An exemplary process to control display 66 is shown in FIG. 4.

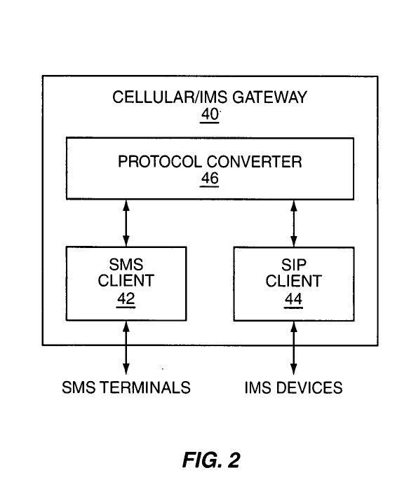

FIG. 2 illustrates the functional elements of the cellular/IMS gateway 40. Cellular/IMS gateway 40 comprises an SMS client 42 at the cellular interface to communicate with mobile terminals in the cellular network 20, and a SIP client 44 at the IMS interface to send and receive SIP messages. A protocol converter 46 translates SMS messages into corresponding SIP messages, and vice versa. SMS messages from a mobile terminal 100 to a predetermined directory number are converted into SIP messages by the protocol converter 46 and forwarded to the SIP Proxy 50.

FIG. 3 illustrates the functional elements of the SMS/MMS Proxy 50 in more detail. The SMS/MMS Proxy 50 comprises a SIP client 54 that communicates with other end devices 60, and an application server 52 that executes service requests and control actions on behalf of mobile terminal 100. SIP client 54 enables sessions to be established with other end devices 60 using SIP. The SIP client 54 may, for example, be a client as shown and described in U.S. patent application Ser. No. 11/114,427 filed Apr. 26, 2005, which is incorporated herein by reference. Application server 52 functions as a proxy on behalf of legacy mobile terminal 100 to establish a presence in the IMS network 30. The application server 52 maintains SIP user identities (e.g. SIP URIs) for non-SIP devices (e.g. mobile terminals 100). Application server 52 also interprets text-based commands from mobile terminal 100 and translates the commands into corresponding SIP transactions. A command interpreter 53 interprets the commands from mobile terminal 100 and, depending on the command, invokes one or more function modules 55. The function modules 55 are subroutines or functions that implement commands from mobile terminal 100.

Application server 52 may store the user identities and corresponding return address in a user database 56. The user database 56 can also be used to store state information for processes initiated on behalf of the users. Using a user database 56 to store user information, however, is not mandatory. The application server 52 could be made stateless by using the return address or number of the mobile terminal 100 to establish a SIP user identity in the IMS network 30. Using the user's return address or number as the SIP user identity eliminates the need to maintain a database to associate user identities with users. One advantage of the stateless approach is that it scales easily to accommodate large numbers of users.

FIG. 4 illustrates an exemplary subscribe/notify process that enables the legacy mobile terminal 100 to receive notifications from an end device 60 in the IMS network 30. In this example, it is assumed that the current state information of the sensor 64 being monitored by Device A is available on the IMS network 30 using the SIP SUBSCRIBE method. Device A may optionally be registered with a SIP registrar. Mobile terminal 100 sends an SMS message containing a subscription request to the cellular/IMS gateway 40 (step a). The subscription request typically includes a device name and event description for the event to which the mobile terminal 100 wants to subscribe. The SMS text message may be formatted as shown below:

SUBSCRIBE
BLDG-2
DOOR-3

In this example, the first line of the SMS text message which reads “subscribe” is a command or service request. The next two lines which read “BLDG-2” and “DOOR-3” are command parameters that SMS/MMS Proxy 50 needs to execute the service request. In this example, mobile terminal 100 is instructing the SMS/MMS Proxy 50 to subscribe to an event identified by a specific device name (BLDG-2) given in the second line of the service request and event name (DOOR-3) given by the third line of the service request. The device name may comprise a SIP URI for an end device or an alias for the end device that can be used by the SMS/MMS Proxy 50 to lookup the corresponding SIP URI. In this example, BLDG-2 is the alias for Device A 60 and DOOR-3 is the name of an event monitored by sensor 64. IMS users can subscribe to the event DOOR-3 by sending a subscription request to Device A 60. Device A 60 may also monitor other events.

SMS gateway 40 receives the SMS message from the mobile terminal 100, converts the message into a standard SIP MESSAGE request, and forwards the converted message to the SMS/MMS Proxy 50 (step b). The SIP MESSAGE request is a request used in SIP to send instant messages. The SMS text message is inserted into the body of the SIP MESSAGE request and forwarded to the SMS/MMS Proxy 50. SMS/MMS Proxy 50 acknowledges the SIP MESSAGE request by sending a “200 OK” response to gateway 40 to acknowledge receipt of the SIP MESSAGE request (step c).

SIP proxy 50 extracts the text message from the SIP MESSAGE request. The extracted text message is passed to the application server 52, which interprets and processes the message. In this example, the SMS/MMS Proxy 50, acting on behalf of mobile terminal 100, uses an identity created for or assigned to the mobile terminal 100 to subscribe to the specified event using the SIP SUBSCRIBE method. The SMS/MMS Proxy 50 sends a SIP SUBSCRIBE request to Device A (step d). The user's SMS return address is recorded in the user database 56 of the SMS/MMS Proxy 50. Device A 60 sends a “200 OK” response to SMS/MMS Proxy 50 to acknowledge receipt of the SIP SUBSCRIBE request (step e), followed by an initial SIP NOTIFY request containing the current status of the event (step f). SMS/MMS Proxy 50 acknowledges the SIP NOTIFY request by sending a “200 OK” response to Device A 60 (step g). The SIP Proxy 50 then notifies mobile terminal 100 of the current state of the event by generating a text message, inserting the text message into the body of a SIP MESSAGE request, and forwarding the SIP MESSAGE request to the gateway 40 (step h). The SIP MESSAGE request contains the SMS address of the mobile terminal 100 in the destination address field of the header. Gateway 40 confirms receipt of the SIP MESSAGE request (step i), and sends an SMS text message to mobile terminal 100 containing the initial state of the event (step j).

When the event being monitored subsequently changes state (door 3 opens or closes), Device A 60 sends a SIP NOTIFY request to SMS/MMS Proxy 50 giving the state of event A to the SMS/MMS Proxy 50, which is acting as the agent of mobile terminal 100 (step k). The SMS/MMS Proxy 50 confirms receipt of the SIP NOTIFY request (step l). The SIP NOTIFY request triggers the application server 52 to generate and send a SIP MESSAGE request (step m) to gateway 40. The SMS return address for mobile terminal 100 is retrieved from the SMS/MMS Proxy's user database 56. The status information for event A is then sent as a SIP MESSAGE request to the SMS gateway 40 for transmission to the mobile terminal 100. The gateway 40 acknowledges receipt of the SIP MESSAGE request (step n). The SMS gateway 40 then encapsulates the status information in an SMS text message and sends the SMS text message to mobile terminal 100 over the cellular network 20 (step o).

Those skilled in the art will appreciate that the subscribe/notify process can be used for a wide variety of events. The SMS/MMS Proxy 50 significantly extends the potential list of subscribers by including anyone with a standard mobile terminal 100 with SMS capability.

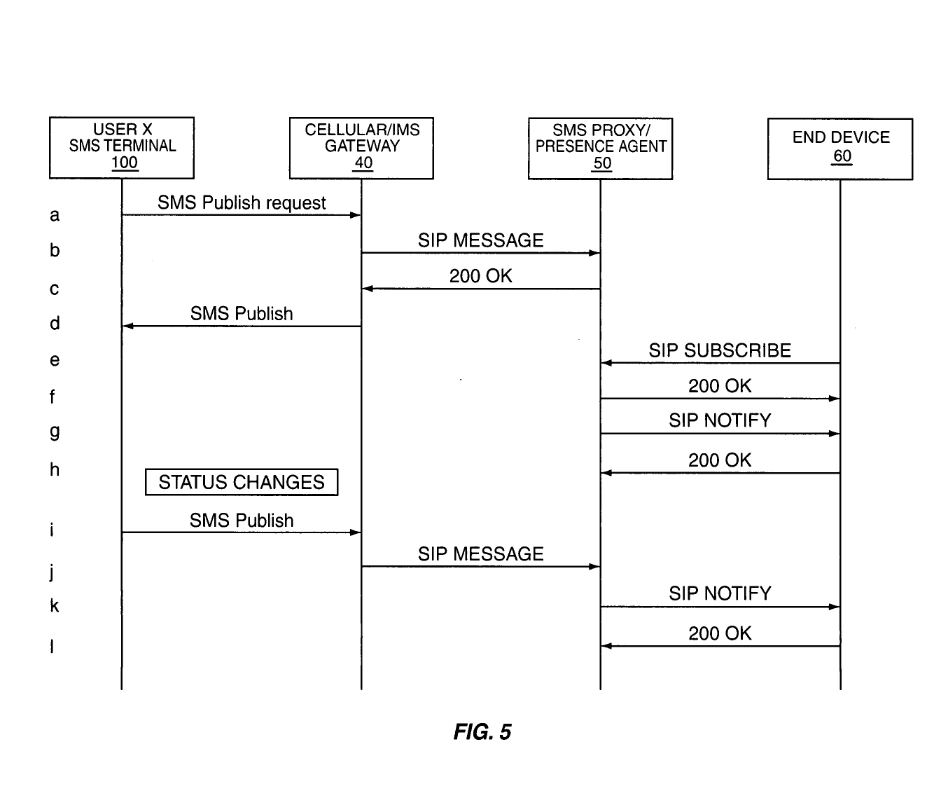

FIG. 5 illustrates an exemplary process that enables the legacy mobile terminal 100 to provide notification services to other end devices 60 in the IMS network 30. In this example, the mobile terminal 100 is providing presence services and the SMS/MMS Proxy 50 functions as a SIP presence agent. Alternatively, the SMS/MMS Proxy 50 could communicate with an external presence agent. Mobile terminal 100 sends an SMS Publish request to the cellular/IMS gateway 40 (step a). SMS gateway 40 receives the SMS message from the mobile terminal 100, converts the message into a standard SIP MESSAGE request, and forwards the converted message to the SMS/MMS Proxy 50 (step b). SMS/MMS Proxy 50 sends a “200 OK” response to gateway 40 to acknowledge receipt of the SIP MESSAGE request (step c). If desired, the gateway 40 can send an SMS Publish response to the mobile terminal 100 to confirm that the presence service has been successfully established (step d).

After the presence service is established, an end user subscribes to the presence service by sending a SIP SUBSCRIBE request to the SMS/MMS Proxy 50 (step e), which is functioning as the presence agent. The SIP Proxy 50 sends a SIP 200 OK response (step f) followed by an immediate SIP NOTIFY request to provide current status information for the mobile terminal 100 (step g). End device 60 acknowledges the SIP NOTIFY request by sending a “200 OK” response to the SMS/MMS Proxy 50 (step h).

When the status of the mobile terminal 100 changes, the mobile terminal 100 generates and sends an SMS Publish request to the cellular/IMS gateway 40 containing the current status of the mobile terminal 100 (step i). The cellular/IMS gateway 40 converts the SMS message into a standard SIP MESSAGE Request and forwards the SIP MESSAGE request to the SMS/MMS Proxy 50 (step j). The SIP MESSAGE request triggers the application server 52 to generate a SIP NOTIFY request and send the SIP NOTIFY request to all subscribers (step k). The subscribers acknowledge the SIP Notify request by sending a SIP 200 OK response (step l).

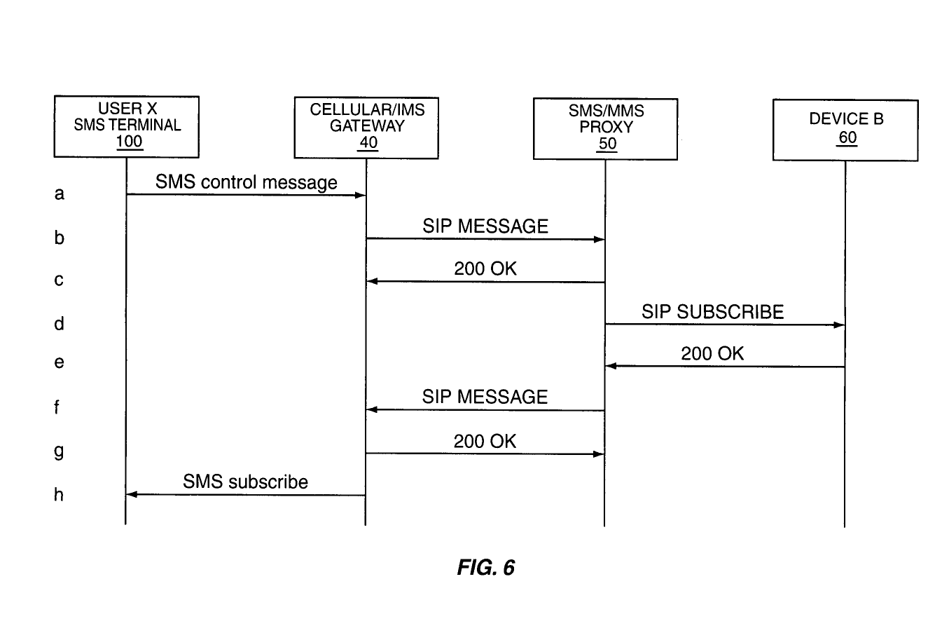

FIG. 6 illustrates a process that can be used to control or configure a remote device, denoted in the example as Device B 60. In this example, Device B 60 controls a display 66 and enables IMS users to remotely update the display 66. The SMS/MMS Proxy 50 extends this capability to mobile terminals 100 having SMS capability.

Mobile terminal 100 sends a control message formatted as an SMS message to the SMS gateway 40 (step a). The control message includes control/configuration information to control the display 66 or other remote device. An example of an SMS message sent by mobile terminal 100 that can be used to update a remote display 66 connected to Device B 60 is shown below.

DISPLAY
LCD-1
HELLO

The first line of the message is a command indicating the action that the mobile terminal 100 wants the SMS/MMS Proxy 50 to take. In this case, the command “display” instructs the application server 52 to display a message on a designated device (LCD-1) given in the second line of the SMS text message. The message to be displayed (HELLO) is given in the third line of the SMS text message.

Gateway 40 receives the SMS text message from mobile terminal 100 and converts the SMS text message into a SIP MESSAGE request containing the control/configuration information in the message body (step b). The SIP MESSAGE request contains the entire SMS text and the return SMS address for mobile terminal 100. SMS/MMS Proxy 50 confirms receipt of the SIP MESSAGE request by sending a 200 OK response to gateway 40 (step c). The application server 52 at the SIP Proxy 50 examines the body of the SIP message and sends a second SIP message containing the control/configuration information to Device B 60 (step d). Device B confirms receipt of the SIP MESSAGE request from the SIP proxy 50 by sending a SIP 200 OK response to SMS/MMS Proxy 50 (step e). If a reply message to mobile terminal 100 is required, the SMS return address for the mobile terminal 100 is retrieved from the SMS/MMS Proxy's user database 56 and the confirmation of the control action success is sent as a SIP MESSAGE request to the SMS gateway 40 for transmission to the mobile terminal 100 (step f). SMS gateway 40 confirms receipt of the SIP MESSAGE request (step g), inserts the control confirmation into an SMS text message, and sends the SMS text message to mobile terminal 100 over the cellular network 20 (step h).

For some applications, the use of the SIP MESSAGE method to communicate information between the IMS devices 60 has significant limitations. For example, a user may want to control a digital camera to capture and send an image file back to mobile terminal 100 for display. Because SIP commonly uses UDP (User Datagram Protocol) for transport, the SIP MESSAGE method may not be able to accommodate the file size of the image. Further, the use of the SIP MESSAGE method for some types of applications may put an unnecessary traffic burden on the IMS network 30.

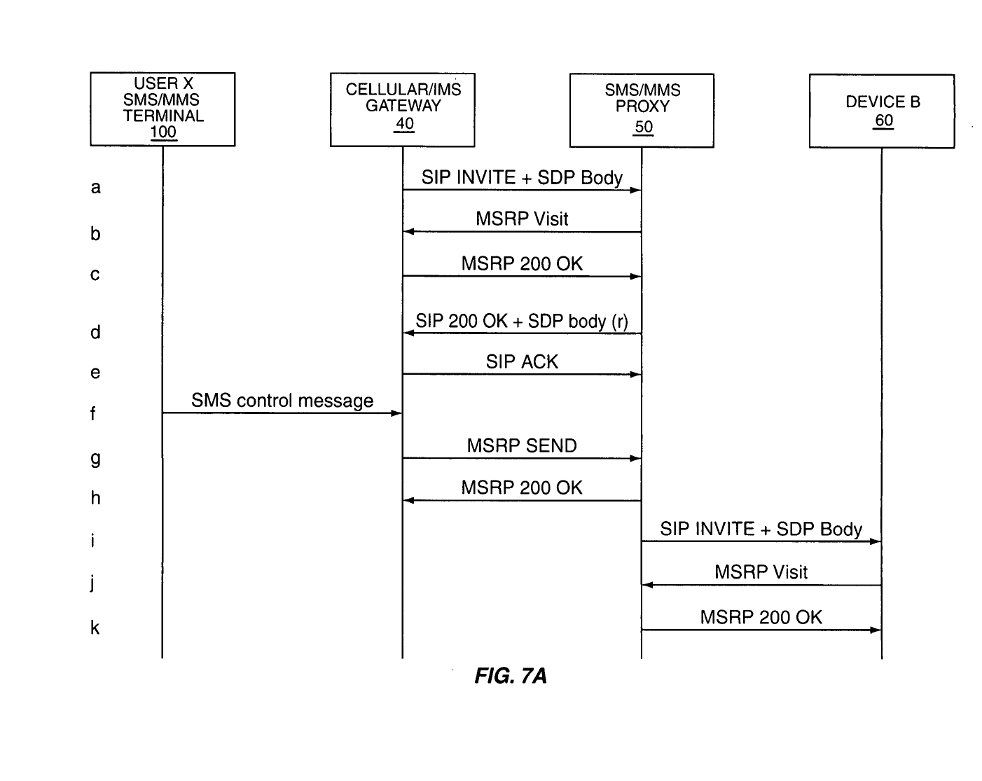

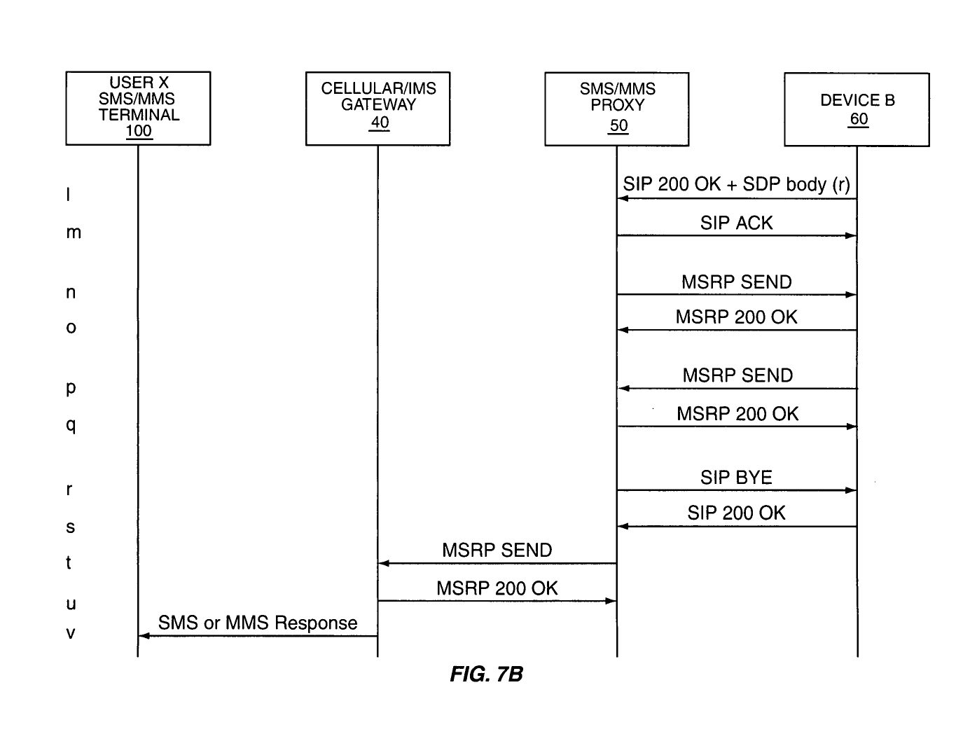

An alternative to the SIP MESSAGE method is to use SIP to establish an MSRP connection between SIP clients (gateway, SMS/MMS Proxy, and M2M device). MSRP accommodates unlimited size messages, and the MIME type field can be used to determine whether an SMS or MMS message is needed to transfer the response from the M2M device 60 back to the mobile terminal 100 over the cellular network 20. FIGS. 7A and 7B illustrate one implementation scheme that uses MSRP to extend the capability of the cellular/IMS gateway 40. The process begins with the establishment of an MSRP connection between the cellular/IMS gateway 40 and the SMS/MMS Proxy 50 (steps a-e). The overhead of creating the MSRP connection is only incurred one time at the start-up. If multiple gateways 40 exist, each gateway 40 connects to the SMS/MMS Proxy 50 via a separate MSRP connection. The gateway 40 sends a SIP INVITE with an SDP body containing the session parameters for the media connection (step a). The SMS/MMS Proxy 50 returns an MSRP VISIT message to the gateway 40 (step b) which is confirmed with a positive response (MSRP 200 OK) (step c) to establish the media connection. At this point, the SIP INVITE request has not been accepted. The SMS/MMS Proxy 50 sends a SIP INVITE response (SIP 200 OK plus SDP body) (step d). The SDP body confirms the MSRP session parameters. The SIP INVITE response is the answer to the SIP INVITE request and contains the network address and port used by the SMS/MMS Proxy 50 for the media connection. The gateway 40 acknowledges the SIP 200 OK response with a SIP ACK message to complete the three-way handshake (step e). Gateway 40 and SMS/MMS Proxy 50 can now exchange messages using the MSRP connection.

Mobile terminal 100 subsequently sends an SMS control message to the gateway 40 (step f). The SMS control message may contain a request to perform some action on behalf of the mobile terminal 100 (e.g., subscribe, unsubscribe, display, etc.). Gateway 40 uses the MSRP SEND method to forward the control information to the proxy 50 (step g). The SMS/MMS Proxy 50 confirms receipt of the MSRP SEND request with an MSRP 200 OK response (step h). The SIP client at the SMS/MMS Proxy 50 passes the control information to the application server 52, which determines what action to take. In this case, the application server 52 determines that an MSRP connection to the M2M device 60 (Device B) is appropriate for the particular service request. The SMS/MMS Proxy 50 establishes an MSRP connection with the M2M device (steps i-m) in the manner as previously described. SMS/MMS Proxy 50 uses the MSRP SEND method (step n) to send control information to the M2M device 60 (Device B). The M2M device 60 confirms the MSRP SEND request by sending an MSRP 200 OK response to SMS/MMS Proxy 50 (step o) and processes the service request or other control information received from the SMS/MMS Proxy 50. If the service request requires a response from the M2M device 60, the M2M device 60 uses the MSRP SEND method (step p) to respond. It should be noted that the MSRP SEND method can be used to transfer a file, such as an image file, video file, or audio file, to SMS/MMS Proxy 50. The SMS/MMS Proxy 50 confirms the MSRP SEND request by sending an MSRP 200 OK response to the M2M device 60 (step q). When the interaction between the SMS/MMS Proxy 50 and M2M device 60 is complete, the SMS/MMS Proxy 50 closes the connection using the SIP BYE method (step r). The M2M device 60 confirms the SIP request by sending a SIP 200 OK response to SMS/MMS Proxy 50 (step s).

SMS/MMS Proxy 50 may send files or other information received from the M2M device 60 to the mobile terminal 100 via the gateway 40. For example, if SMS/MMS Proxy 50 has received an image file from the M2M device 60, the SMS/MMS Proxy 50 can send the image file to mobile terminal 100. In this case, the SMS/MMS Proxy 50 uses the MSRP SEND method to send the file or other information to gateway 40 (step t). The gateway 40 confirms the MSRP SEND request with an MSRP 200 OK response (step u). Gateway 40 encapsulates the response in an SMS or MMS message as appropriate and sends the response to the mobile terminal 100 over the cellular network 20 (step v).

The combination of a gateway 40 and SMS/MMS Proxy 50 effectively extends the benefits of the IMS network 30 to non-IMS devices 100, such as cellular phones with SMS capability. Using SMS, MMS, or other messaging applications, a mobile terminal 100 can control and configure remote M2M devices 60 and monitor complex processes for specific events using SIP subscribe/notify methods. The SMS/MMS Proxy 50 also establishes a presence on the IMS network 30 for non-IMS devices 100 so that non-IMS devices 100 can provide services to IMS devices 60 connected to the IMS network 30.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of providing IP services to non-SIP devices, said method comprising configuring a proxy to maintain SIP user identities in said IP network for non-SIP devices and to conduct SIP transactions using those user identities on behalf of said non-SIP devices.

2. The method of claim 1 wherein the proxy conducts SIP transactions responsive to messages received from non-SIP devices via a gateway.

3. The method of claim 2 wherein said messages comprise text messages encapsulated within a SIP request by said gateway.

4. The method of claim 3 wherein configuring the proxy comprises configuring the proxy to interpret said text messages and translate said messages into corresponding SIP transactions.

5. The method of claim 1 wherein conducting said SIP transactions includes subscribing to a notification service on behalf of non-SIP devices.

6. The method of claim 5 further comprising configuring the proxy to forward received notifications to said non-SIP devices.

7. The method of claim 1 wherein conducting said SIP transactions includes establishing media connections for receiving or sending media on behalf of said non-SIP devices.

8. The method of claim 7 further comprising configuring the proxy to receive media and forward said media to said non-SIP devices.

9. The method of claim 7 further comprising configuring the proxy to receive media from said non-SIP devices and to send said media to specified addresses for said non-SIP devices.

10. The method of claim 1 wherein said SIP transactions include message transactions.

11. The method of claim 10 wherein said message transactions are used to send control information to control a remote device.

12. A proxy for providing IP services to non-SIP devices, said proxy comprising:
a SIP client to establish communication with SIP devices connected to said IP network; and
an application server configured to maintain SIP user identities in said IP network for non-SIP devices and to conduct SIP transactions with SIP devices using those user identities on behalf of said non-SIP devices.

13. The proxy of claim 12 wherein the application server conducts SIP transactions responsive to messages received from non-SIP devices via a gateway.

14. The proxy of claim 13 wherein said messages comprise text messages encapsulated within a SIP request by said gateway.

15. The proxy of claim 14 wherein the application server is configured to interpret said text messages and translate said messages into corresponding SIP transactions.

16. The proxy of claim 12 wherein said application server conducts the SIP transactions by subscribing to a notification service on behalf of non-SIP devices.

17. The method of claim 16 wherein the application server is further configured to forward received notifications to said non-SIP devices.

18. The proxy of claim 12 wherein said application server conducts said SIP transactions by establishing media connections for receiving or sending media on behalf of said non-SIP devices.

19. The proxy of claim 18 wherein the application server is further configured to receive media and forward said media to said non-SIP devices.

20. The proxy of claim 18 wherein the application server is further configured to receive media from said non-SIP devices and to send said media to specified addresses for said non-SIP devices.

21. The proxy of claim 12 wherein said SIP transactions include message transactions.

22. The proxy of claim 21 wherein said message transactions are used to send control information to control a remote device.

23. A method of providing IP services to non-SIP devices, said method comprising:
configuring a proxy to maintain SIP user identities for non-SIP devices in said IP network;
receiving messages via a gateway from said non-SIP devices;
translating said messages into SIP transactions; and
conducting said SIP transactions on behalf of said non-SIP devices using said SIP user identities responsive to said text messages.

24. The method of claim 23 wherein conducting said SIP transactions on behalf of said non-SIP devices comprises subscribing to notification services using said SIP user identities.

25. The method of claim 23 wherein conducting said SIP transactions on behalf of said non-SIP devices comprises sending control information for controlling remote devices.

26. The method of claim 25 wherein sending control information for controlling remote devices comprises sending control information using the SIP MESSAGE method.

27. The method of claim 23 wherein conducting said SIP transactions on behalf of said non-SIP devices comprises establishing media connections with SIP devices for sending or receiving media.

28. The method of claim 27 further comprising sending control information for controlling a remote device on behalf of said non-SIP devices using said media connection.

29. The method of claim 27 further comprising sending or receiving media on behalf of said non-SIP devices using said media connection.

30. The method of claim 23 wherein conducting said SIP transactions on behalf of said non-SIP devices comprises providing notification services to SIP users on behalf of said non-SIP devices.

31. The method of claim 30 wherein providing notification services to SIP users on behalf of said non-SIP devices comprises providing presence services to SIP users on behalf of said non-SIP devices.

32. The method of claim 30 further comprising receiving state information from said non-SIP devices relating to said notification services, and sending notifications to subscribing users responsive to changes in said state information.

33. The method of claim 32 wherein said state information is contained in a text message from said non-SIP devices.

34. The method of claim 33 wherein said messages from said non-SIP devices comprise text messages.

35. A proxy for providing IP services to non-SIP devices, said proxy comprising:
a SIP client to establish communication with SIP devices connected to said IP network; and
an application server configured to:
maintain SIP user identities in said IP network for non-SIP devices;
receive messages via a gateway from said non-SIP devices;
translate said messages into SIP transactions; and
conduct said SIP transactions on behalf of said non-SIP devices using said SIP user identities responsive to said text messages.

36. The proxy of claim 35 wherein said application server conducts SIP transactions on behalf of said non-SIP devices to subscribe to notification services using said SIP user identities.

37. The proxy of claim 35 wherein said application server conducts SIP transactions on behalf of said non-SIP devices to send control information for controlling remote devices.

38. The proxy of claim 37 wherein said application server sends control information using the SIP MESSAGE method.

39. The proxy of claim 35 wherein said application server conducts SIP transactions on behalf of said non-SIP devices to establish media connections using said SIP user identities for sending or receiving media.

40. The proxy of claim 39 wherein said application server is further configured to send control information for controlling a remote device on behalf of said non-SIP devices using said media connection.

41. The proxy of claim 39 wherein said application server is further configured to send or receive media on behalf of said non-SIP devices using said media connection.

42. The proxy of claim 35 wherein said application server conducts SIP transactions on behalf of said non-SIP devices to provide notification services to SIP users on behalf of said non-SIP devices.

43. The proxy of claim 42 wherein said application server receives state information from said non-SIP devices relating to said notification services, and sends notifications to subscribing users responsive to changes in said state information.

44. The proxy of claim 43 wherein said state information is contained in a text message from said non-SIP devices.

45. The proxy of claim 42 wherein said notification services comprise presence services.

46. The proxy of claim 35 wherein said messages from said non-SIP devices comprise text messages
